(19) United States
(12) Patent Application Publication
(10) Pub. No.: US 2010/0146704 A1
(43) Pub. Date: Jun. 17, 2010

(54) Fail-Proof Control For Hospital Beds

(76) Inventor: Hans-Peter Barthelt, Esslingen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/515,932

(22) PCT Filed: Oct. 26, 2007
(86) PCT No.: PCT/EP07/09298

§ 371 Date: Jan. 20, 2010

(30) Foreign Application Priority Data
Nov. 21, 2006 (DE) 10 2006 055 205.9

(51) Int. Cl. A61G 7/018; H02H 7/08

(52) U.S. Cl. 5/600; 318/484

(57) ABSTRACT

A control system for nursing care beds contains additional current and state (switch-on, switch-off) monitoring of the motors to sense potential thermal overload conditions. In an embodiment of the invention, if the control system detects that a motor has remained switched-on longer than a predetermined time and current is also flowing during this time, the control transitions to a blocking state to prevent thermal overloading of the motors.

### CROSS-REFERENCE TO RELATED APPLICATIONS

This patent application is the national phase of PCT/EP2007/009298, filed Oct. 26, 2007, which claims the benefit of German Patent Application No. 10 2006 055 205.9, filed Nov. 21, 2006.

### FIELD OF THE INVENTION

The present invention relates generally to nursing care beds, and more particularly to nursing care beds that are electrically controlled.

### BACKGROUND OF THE INVENTION

Nursing care beds are often used by physically handicapped people. The individual moving elements of such beds are therefore actuated with the aid of electric motors, so that the bed can be adjusted without requiring exertion on the part of the user.

The control of the electric motors must be particularly reliable with respect to the limited movement possibilities of the patients. In particular, it must be ensured that the motors are not thermally overstressed. In order to guarantee this, the motors are usually equipped with limit switches, so that, in fact, current flows only for as long as the motor needs to come to a limit position. Even if the user actuates a corresponding key of the input keyboard longer than the time needed for the motor to reach the limit position, an overload cannot take place because the motor current is expressly switched off by the limit switch.

Despite the limit switches, safety can be compromised if there are defects in the electric cables or in the limit switches, such that the desired limit switch-off is prevented. Therefore, a control is needed that prevents such safety problems.

### OBJECTS AND SUMMARY OF THE INVENTION

It is an object of the invention to provide an electronic bed control for beds that moving parts driven with electric driving motors with an input device to receive user control commands for the driving motors and a polarity-reversing switch via which the driving motor can be selectively connected with first or second polarity to a voltage source and a device to time the motor current flow and forcibly bring the polarity-reversing switch or other switch device to the switch-off state if the current flow exceeds a predetermined limiting value.

It is a further object of the invention to provide a control as described above, further including a bistable safety switch that can be switched at least once from the conducting state to the nonconducting state by a pulse-like current supply, the bistable safety switch being in series with the polarity-reversing switch.

It is yet a further object of the invention to provide a control for nursing care beds as described above, wherein the individual parts are driven and can be set in motion via electric motors driven by user commands to move the individual elements of the bed, and the movement of the individual element continues until the user lets go of the key or the motor reaches the limit position, and wherein the control also has a polarity-reversing switch, so that the motors can run, selectively, in the opposing direction, via permanent-excited motors whose direction of rotation can be specified by a change in polarity. The polarity-reversing switch may be configured to interrupt the motor current in the absence of input signals or an additional switching device can lie in series with the polarity-reversing switch, so as to switch off the motor current if the user releases the pertinent key.

A monitoring device is provided, which is set up so as to monitor the current flow to the at least one driving motor, the switch-on state of the polarity-reversing switch, or the switch that lies in series with it. A processor device works together with the monitoring device and contains a program section with a timer. The timer is started every time a signal comes from the monitoring device, which shows that either current is flowing or that there is a switch-on signal for the polarity-reversing switch, and to start the motor. In this way, not only is the actual current flow monitored, but also the manner in which current flows, so as to avoid risks due to defects in the control. Such defects can appear, for example, if the patient accidently lies on a manual keyboard and at the same time, a motor limit switch fails, or a cable is damaged, and thus, a continuous signal for a motor is also, in turn, delivered, with failure of the limit switch or the switching off of the motor current in the control itself due to a failure of semiconductor components.

With the aid of a timer, a determination is made whether the actual or possible current flow condition lasts longer than a predetermined time. Should this be the case, the control is blocked in such a way that any further conducting or processing of control signals or turning on of motors becomes impossible. The current to the driving motor can be forcibly interrupted under circumstances independent of the polarity-reversing switch.

In this way, the redundancy of the safety system is substantially increased, and defects of individual semiconductor components cannot cause damage. Moreover, since the control is blocked, the user can sense that a dangerous defect exists. With the entire system out of order, the user is forced to have the entire bed and control system inspected by suitable maintenance personnel. The forcible switching of the entire system can also be done with the aid of an additional safety switch lying in the motor current supply line(s).

It is a further object of the invention to provide a system as described above, wherein the current supply to the processor device is controlled via the safety switch, so that in case of a defect, the processor device is also automatically and permanently turned off

In an embodiment of the invention, a simple safety switching device is formed by a bistable relay, which is normally in the operating state without an external supply of current, which permits a supply of current to the control and/or the motors. If the processor device should recognize a dangerous defect, which warrants a blocking of operation, the control of the bistable relay is activated and switched over permanently to the other operating state, which interrupts the supply of current to the motors and/or the control. Only by the supply of another current pulse of reversed polarity or to another winding is it possible to reset the safety switch again to the state in which a current supply within the control is possible.

Advantageously, the control can have a special operation in which the barrier for the polarity-reversing switch(es) or the safety switch can be reset. This special operation may be implemented, for example, by entering a predetermined sequence of keys on the manual control within a specific window of time.

With respect to alternative and additional features, the input device may have a speech input as well as or instead of a keyboard. Also, for additional safety, the control may comprise two processors to monitor each other. Safety may be further enhanced if the processors are diversified with respect to the hardware, and even greater safety can be attained if the programs that run in the processors are diversified with respect to the software. For example, software diversity can be attained when one of the processors contains the complete control program, and the other processor manages only the safety functions. The probability of hidden program defects is thus substantially reduced because the safety functions can be programmed in a safe and clear manner, and finally, in this way, the effects of defects in the other program can be eliminated in combination with the control as described above.

A simple polarity-reversing switch having only semiconductor elements may be used. The polarity-reversing switch can contain at least two half-bridges, wherein the pertinent driving motor can be in the bridge arm. If the polarity-reversing switch has three half-bridges, three motors, as a whole, can be switched into the three bridge arms created with the half-bridges, wherein there is a driving motor in each bridge arm. In this way, the number of required half-bridges, which is equal to the number of motors, is reduced. The arrangement permits the control of each individual motor or also of two motors, but then with opposed polarity.

The use of half-bridges also readily makes possible an implementation of a current limiter, wherein for the reduction of the reversing loss performance of each transistor in the half-bridges, during a half-wave of the supplying full-waves of rectified supply voltage, the upper transistor is used for the switch-off, and in the next half-wave, the lower transistor. The other transistor in each case is currentless in the corresponding state that is needed during the next phase in each case.

The monitoring device can contain a current sensor. This current sensor can be in the current line to all motors, so as to monitor in a simple manner all motors and their operating states. The current sensor can be connected to the inputs of the two processors. It is also possible for the current sensor to have one or more current sensor resistances, which are connected to the inputs of the processors, either all together or separately from one another.

To monitor the switching states of the polarity-reversing switches, the other processor, which can contain only a part of the entire program, can be connected to input connections at the control inputs of the polarity-reversing switches. In this way, the other processor can control which switching states in the polarity-reversing switches will be turned on by the other processor.

To prevent the processor device from resetting arbitrarily to the normal operating state after the cessation of the supply voltage, the processor preferably contains a nonvolatile storage unit in which a variable is stored, which indicates the blocking state. This variable is retrieved at each startup, and the control can then go over automatically to the blocking state if so required.

A particularly simple switching is attained if a safety switch lies in the current line to the motors, and in addition, works autonomously. This safety switch can, for example, comprise a bistable relay, which is normally in the state that permits current supply to the motors at the time of delivery of the control. In case of a defect, the bistable relay switches to another state, wherein the control becomes inoperable. The bistable relay can be controlled either from the main processor or a suitable autonomous processor.

The following description of the figures explains aspects of the invention. Those of skill in the art can deduce minor details that are not described, in the accustomed manner, from the drawings, which, in this respect, supplement the description of the figures. It is contemplated that numerous modifications are possible.

The following drawings are not necessarily true to scale. For example, certain areas may be depicted in an enlarged manner to illustrate the essential details. Moreover, the drawings are simplified and do not contain every detail that may be present in the practical embodiment.

Other objects and advantages of the invention will become apparent upon reading the following detailed description and upon reference to the drawings, in which:

### BRIEF DESCRIPTION OF THE DRAWINGS

FIG. 1 shows a perspective representation of a nursing care bed in accordance with an embodiment of the invention, with an illustration of the individual sections of a reclining frame;

FIG. 2 shows the bed according to FIG. 1 in a chair position;

FIG. 3 shows a basic circuit diagram of a first embodiment of the defect-proof control in accordance with an embodiment of the invention, using two processors and polarity-reversing switches that are being turned off;

FIG. 4 shows a simplified flow chart for the control according to FIG. 1;

FIG. 5 shows a second embodiment of the control switch in accordance with an embodiment of the invention, using an additional safety switch; and

FIG. 6 shows a basic circuit diagram using a group of half-bridges to control three motors.

While the invention is susceptible to various modifications and alternative constructions, certain illustrative embodiments thereof have been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

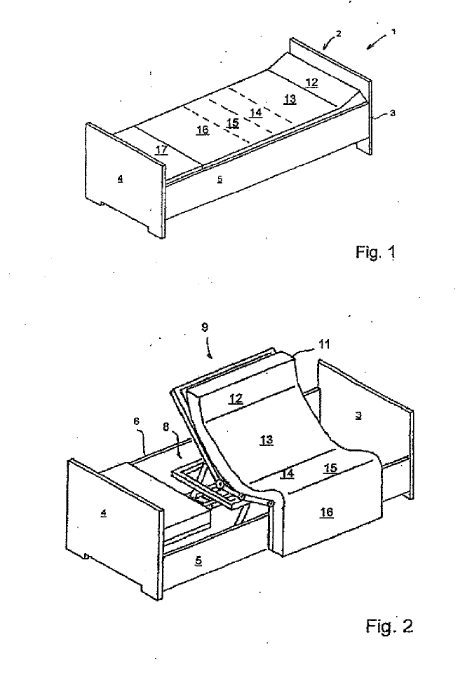

In a perspective representation, FIG. 1 shows the rotating and sitting-up bed 1 in the lying position, whereas FIG. 2 shows bed 1 in the sitting or chair position. Bed 1 includes a bed frame 2 with a head part 3, a foot part 4, and side walls 5 and 6. The side wall 5 facing the observer is in the lying position. The side wall 5 is at a greater distance from the floor, so that between the lower edge of the side wall 5 and the floor, there is a gap that makes it possible for the care personnel (e.g., nurse, caretaker, doctor, etc.) to place their toes under the bed if necessary. The side wall 5 is supported so it can move to the sitting position of the bed 1 in a position displaced farther downward, as shown in FIG. 2. The special support of the side wall 5 is, for example, explained in detail in DE 199 12 987 A1.

A lever 8 is located within the bed frame 2, as can be partially seen in FIG. 2. A reclining frame 9 is affixed on the lever 8, via a turning hinge (not shown) and the reclining frame carries a mattress 11. The lever 8 is used to bring the reclining frame 9, together with the mattress 11 on it, to various heights. The structure of the lever 8 is explained in detail, for example, in DE 10 2004 019 144 A1, to which reference is made in this respect, and which is herein incorporated by reference in its entirety.

The reclining frame 9 is divided into several sections which move with respect to one another. The designations of the individual sections essentially correspond to the designation of the body parts resting thereon for a human lying in bed.

Directly at the head end, there is a head section 12 which can swivel, and in FIG. 1 is swiveled upward. This section is followed by a back section 13 toward the foot end. The back section 13 is hinged on a central section 14, which, in turn, is connected directly, via the rotating hinge, to the lever or lifter 8. A thigh section 15 follows the central section 14, and merges into a lower leg section. Finally, the bed surface also forms a foot section 17. In the rotated state, the foot section 17 remains stationary in the bed, and only the sections 12 to 16 are moved. The individual sections of the reclining frame 9 and the lever 8 and the rotating device are moved via permanent-excited gear motors in an embodiment of the invention.

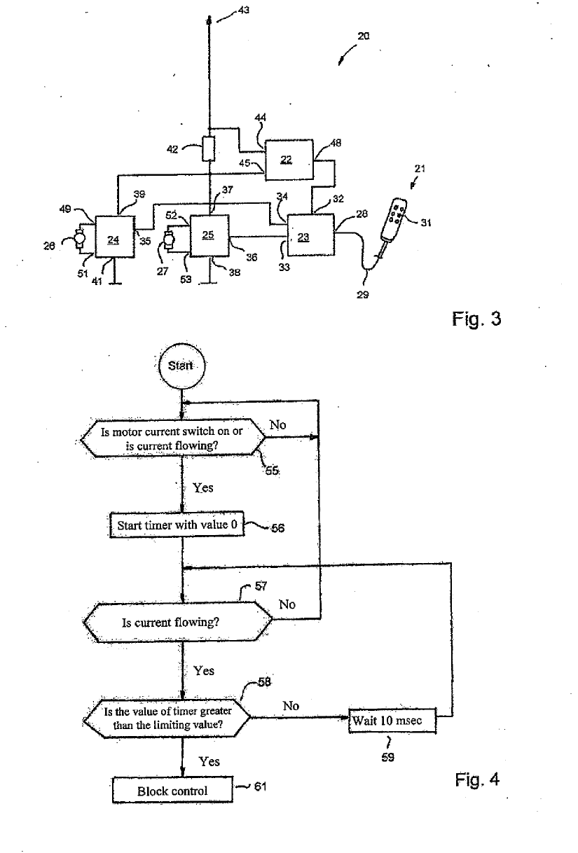

FIG. 3 shows a basic block diagram 20 of the system used to control the individual gear motors via a manual keyboard 21. Two processors 22 and 23 and two polarity-reversing switches 24 and 25 are associated with the system 20. For each polarity-reversing switch 24 and 25, a correlated motor 26 or 27 is supplied with current, wherein the polarity can be reversed.

The two polarity-reversing switches 24, 25 and the motors 26, 27 connected to them are illustrated merely as an example. Generally, the number of polarity-reversing switches and the number of motors that are actuated via the control 20 correspond to the number of motors that the nursing care bed 1 contains.

The block designated by 23 in FIG. 3 symbolizes an interconnection or component, consisting of a CPU and a program and data storage element. The unit thus formed, which may consist of several hardware-technical units, is designated, as a whole, as a processor. The same arrangement may be used for processor 22. The CPUs contained therein and/or the program and data storage elements are preferably diverse with regard to hardware. The programs stored therein are also diverse, at least in the sense that the control programs that are contained in them are not the same. Example differences are explained in detail further below.

The processor 23 has an input 28 to which the manual keyboard 21 is connected via a multipole cable 29. The manual keyboard 21 has a number of individual keys 31. Upon actuating a key, the motor with which this key is correlated switches on in the pertinent rotating direction.

Via another port 32, the processor 23 is connected to the processor 22. Ports 33 and 34 form signal outputs, to which inputs 35, 36 of the polarity-reversing switches 24, 25 are connected. The polarity-reversing switch 25 has a current supply input 37 and a ground connection 38, which is connected to the circuit ground.

In a similar manner, the polarity-reversing switch 24 also contains a current supply connection 39 and a ground connection 41. The two current supply connections 37 and 39 are together connected to a current sensor resistance 42, whose hot end is connected to a current supply.

Two input connections 44 and 45 of the processor 22 are parallel to the current sensor resistance 42. Two other inputs 46 and 47 are connected to the inputs 35 and 36 of the two polarity-reversing switches 24 and 25. An I/O port 48 is connected to the I/O port 32 of the processor 23.

It will be appreciated that the illustrated connections can be unipolar or multipolar connections, depending upon the manner in which they are used. Those of skill in the art will be familiar with how many poles the connection respectively contains.

For the sake of completeness, finally, it should also be mentioned that the two motors 26 and 27 are at corresponding current supply outputs 49-53 of the two processors 24 and 25.

The operation of the circuit is explained below in connection with FIG. 4. It is assumed to this end, for the sake of the example, that the upper row of keys 31 corresponds to the control of the back part 13 that is moved via the motor 27. The second row of keys 31 on the manual keyboard 21 controls the thigh part and the foot part 15, 16 that are moved via the motor 26. If a key is not actuated, the processor 23 does not emit any corresponding control signals to the polarity-reversing switches 24, 25 on its two outputs 33 and 34. The two motors 26 and 27 thus remain currentless.

If the user would like the back part to lie flat, he or she actuates the corresponding key 31 in the upper row on the manual keyboard 21. The processor 23 receives a corresponding electrical signal via the cable 29, which it examines, depending on the position of the bed, for reliability. It then transmits, via its output 33, a control command to the polarity-reversing switch 25. The polarity-reversing switch then turns on the current for the motor 27 with the corresponding, required polarity. When the user releases the corresponding key, the control signal at the output of the processor 23 disappears, and the polarity-reversing switch 25 interrupts the current supply to the motor 27.

In a similar manner, the same control takes place for the motor 26 with the keys 31 of the second row. Since, as indicated above, the bed may have a large number of movement possibilities, the control 23 must be examined as to whether the desired movements in the pertinent operating position of the bed are possible or would lead to a dangerous or damaging situation. To this end, other position switches are also distributed in the bed; they can also be connected to the control 23. With respect to the invention under consideration, however, this is not of importance.

If the user desires to raise the back part 13 of the bed and has actuated the corresponding key 31, the control 23, as stated above, transmits a corresponding signal to the polarity-reversing switch 25. This signal transmitted at the output 33 is simultaneously intercepted and examined by the processor 22.

Furthermore, the running motor 27 produces a drop in voltage at the resistance 42. This voltage signal also arrives at the processor 22 via the inputs 44 and 45. Thus, the processor 22 may detect in two ways that the motor 27 is or is about to run.

In the processor 22, a program section is implemented as is shown in the simplified drawing of FIG. 4. The processor 22 constantly monitors in an interrogation block 55 whether the motor current is turned on, that is, whether a voltage drop that is greater than a predetermined limiting value appears at the resistance 42, or whether a signal to turn on one of the polarity-reversing switches 25, 26 is transmitted at one of the monitored outputs 33 or 34 of the processor 23. If this is not the case (i.e., the motor current is not turned on), the program goes back to the beginning of the interrogation block 55.

However, as soon as one of the two conditions is fulfilled, the program goes on to an instruction block 56. A timer or stopwatch that counts up a time with predetermined steps is started in the instruction block 56. After starting the timer in the instruction block 56, the program arrives at an interrogation block 57. At this place in the program, monitoring is carried out as to whether the motor current continues to flow, or a switch-on signal for one of the motors 26, 27 is transmitted, or whether both conditions are present. Furthermore, a determination is made of the value to which the timer has counted in the meantime. If motor current still flows or there is still a corresponding command signal for switching on the motor current, but the timer has not yet reached its limiting value, the program goes to an instruction block 58, and waits there approximately 10 msec before the program goes back to the beginning of the interrogation block 57. The waiting time of 10 msec is arbitrary and can be replaced by any other arbitrary but sufficiently short time.

If there is no defect, that is, the switch-on time for the pertinent motor or the current flow time is shorter than the specified limiting value, the program in the loop will determine via the interrogation blocks 57, 58 (and the instruction block 59 in the interrogation block 57) that the motor current has ceased and also that the control signal for the motor was turned off. Thus, the program returns to the beginning of the interrogation block 55.

If, however, a double defect exists, which leads to the motor current remaining turned on and continuing to flow, which could cause a dangerous thermal overload and a motor fire, the situation is entered in advance in the interrogation block 58, that the real value to which the variable timer has counted exceeds a specified limiting value. In such a case, the program continues with the instruction block 61, and the entire control or at least a relevant part thereof is blocked.

The time loop is set in such a way that a thermal overload is reliably prevented, i.e., sufficient time is not allowed for thermal overload to occur.

In the interrogation block 57, the conditions are linked with “or,” which means that a blocking of the control does not occur if one or both variables vanishes before reaching the time limiting value. The blocking will occur, for example, in that the processor 22 acts correspondingly on the processor 23 and prevents it from continuing to give the corresponding control signals to the motors. The polarity-reversing switches 24 and 25 are turned off, and the potential for danger vanishes.

In contrast to the representation in FIG. 3, in which only the processor 22 is connected to the current sensor resistance 42, there is also the possibility of connecting the processor 23 in parallel with corresponding inputs to the sensor resistance 42, so that both processors 22 and 23 independently carry out the same monitoring function. Finally, it is also possible to use two sensor resistances, wherein each of the two sensor resistances is correlated with one of the two processors 22, 23. Moreover, in an embodiment of the invention, instead of the current, the current-time integral is evaluated as a limiting value.

FIG. 5 shows a modified embodiment of the control according to FIG. 3. In this embodiment, a bistable relay 62 is also provided in the supply line to the sensor resistance 42. The bistable relay 62 has two control windings 63 and 64. One of the two control windings, namely, the control winding 64, is connected to the I/O port 48 of the processor 22. The other control winding 63 is at two separate input connections. The processor 22 or the processor 23 works as described before.

In the delivery state, the switch contact of the bistable relay 62 is closed, i.e., there is a galvanic connection from the current supply 43 to the motors 26 and 27, which is controlled via the polarity-reversing switches 24 and 25.

The processor 22 works as previously described. If a defect causes it to arrive at the limit switches of the motors in connection with an erroneous control via the manual keyboard in the instruction block 61, it emits, at its I/O port 48, a control signal for the magnetic winding 64, which subsequently converts the bistable relay 62 to the switch-off state. The current connection between the motors 26, 27 and the current supply 43 are thus interrupted, forcibly and independently of the polarity-reversing switches 24, 25.

A restart occurs only in that the other magnetic winding 63 receives a current, so as to bring back the bistable relay to the delivery state. The current supply of the relay 62 can be carried out either via the processor 23 or via a voltage supplied from the outside. If the resetting of the bistable relay 62 to the normal operating state is to take place via the processor 23, an additional connection is provided between an I/O port and the magnetic winding 63. The resetting occurs, for example, in that a certain key sequence is followed on the manual keyboard 21 within a given time window.

The control of the relay 62, in the case of a defect, that is, the control of the magnetic winding 64, can also take place via a corresponding coupling via the processor 23 in an embodiment of the invention.

As will be appreciated from the above, the processor 22 need not contain the complete control program. It is sufficient for the processor 22 to process the safety-relevant time monitoring. Such a program is substantially simpler and thus more defect-proof to program than the complicated program of the processor 23.

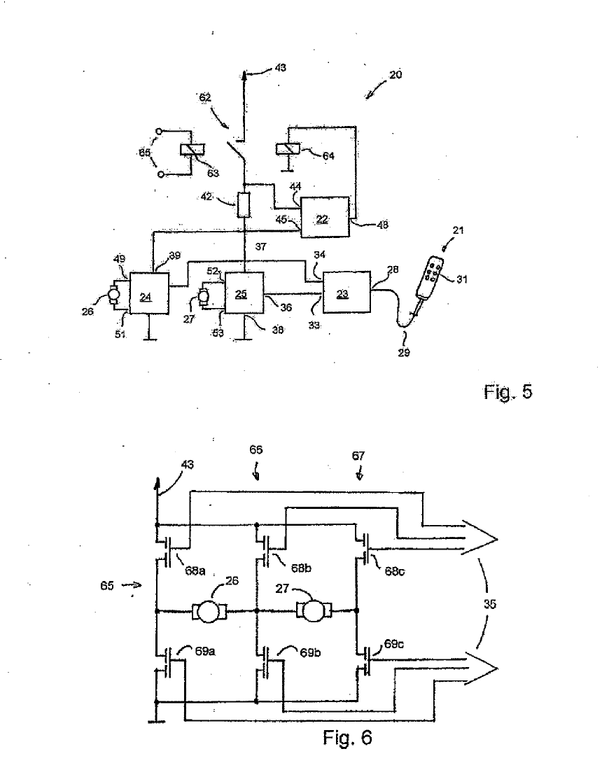

FIG. 6 shows the basic circuit diagram of a modified polarity-reversing switch 24. The polarity-reversing switch 24 contains, accordingly, several half-bridges 65, 66, and 67, of which each has two field effect transistors 68a or 69a in series between the circuit ground and the current supply 43. The half-bridge 66 has corresponding transistors 68d and 69d or 68c and 69c in the half-bridge 67. In this way, a total of three bridge arms are formed between the half-bridges 65, 66; 66, 67, and 67, 65. Every bridge arm includes one of the motors 26 and 27 or another motor 27a. If, for example, the motor 26 is started in one rotating direction, the field effect transistor 68a and the field effect transistor 69b are switched on via the I/O port 35.

The reverse rotation direction of the motor 26 is obtained by switching on the transistor 68b and the transistor 69a. In this case, the two adjacent motors 27 and 27a remain currentless because all field effect transistors 68c and 69c remain turned off in the half-bridge 67.

As can be seen, the same analogous operating state is valid also for all other motors. Moreover, the arrangement can be supplemented by other half-bridges. Beyond four half-bridges, two motors can be operated independently of one another. The advantage of the arrangement is that the number of half-bridges corresponds with the number of motors and thus reduces the use of expensive semiconductor devices.

Finally, there is an advantage in the arrangement in that the reversing switch loss performance loss can be halved. If it is assumed that the switch operates with a current limitation, wherein upon reaching the limiting current, for example, in motor 26, selectively, the field effect transistor 69b or the field effect transistor 69b or the field effect transistor 68a is turned off, there is the possibility of carrying out this switching off, successively, by the other transistor, wherein one of the transistors is always switched powerless. The switch-off power and the re-switch-on power can thus be switched periodically, back and forth, between the two transistors. Therefore, for every transistor, the loss that appears when switching off or on is halved. For the sake of clarity, the required recovery diodes are not depicted.

It will be appreciated that a novel control switch system for nursing care beds provides additional current and switch-on continuous monitoring of the motors. If the motors remain turned on longer than a predetermined time and current flows at the same time, the control arrives at a blocking state, so as to prevent a thermal overload of the motors. However, it will be appreciated that the foregoing methods and implementations are merely examples, and that these illustrate a preferred technique and system. However, it is contemplated that other implementations of the invention may differ in detail from the foregoing examples. As noted earlier, all references to the invention are intended to reference the particular example of the invention being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Moreover, any combination of the above-described elements in all possible variations thereof is encompassed by the invention unless otherwise indicated herein or otherwise clearly contradicted by context. Accordingly, this invention includes all modifications and equivalents of the subject matter recited in the claims appended hereto as permitted by applicable law.

1. Control (20) for beds that have several parts (12.17), which move with respect to one another, and electric driving motors ((26, 27) for them;
with an input device (21), via which the user can give control commands to switch on driving motors (26, 27);
with a process device (22, 23), to which the input device (21) is connected and which has control outputs (33, 34);
with at least a polarity-reversing switch (24, 25), which has a control input (35, 36) to which the at least one driving motor (26, 27) is connected, and via which the driving motor (26, 27) can be connected, selectively, with a first or a second polarity to a voltage source (43), wherein its control input (35, 36) is connected to the processor device (22, 23) and wherein the motor current can be switched on and off, either via the polarity-reversing switch or a switch lying in series; and
with a monitoring device (22, 42) to monitor the current flow over time through the pertinent driving motor (26, 27), which is connected to the polarity-reversing switch (24, 25);
wherein the processor device (22, 23) has a program section (FIG. 4) with a timer that starts with the beginning of the current flow for the driving motor (26, 27) and runs during the continual current flow, wherein the timer is reset each time the current flow disappears; and
wherein the process device (22, 23) forcibly brings the polarity-reversing switch (24, 25) or another switch device (62) to the switch-off state if the timer exceeds a prespecified limiting value.

2. Control for beds that have several parts (12.17), which move with respect to one another, and electric driving motors (26, 27) for them;
with an input device (21), via which the user can give control commands to switch on driving motors (26, 27);
with a processor device (22, 23), to which the input device (21) is connected, and which has control outputs (33, 34);
with at least one polarity-reversing switch (24, 25);
which has one control input (35, 36);
which is connected to the at least one driving motor (26, 27); and
via which the driving motor (26, 27) can be connected to a voltage source (43), selectively, currentless or with a first or a second polarity, wherein the control input (35, 36) is connected to the processor device (22, 23); and
with a monitoring device (42, 22) to monitor the current flow over time through the driving motor (26, 27), which is connected to the polarity-reversing switch (24, 25);
with a safety switch (62),
which has two stable switching states, wherein it can be switched at least once in a direction from the conducting state to the nonconducting state by a pulse-like current supply
which lies in series with the at least one polarity-reversing switch (24, 25);
which is controlled by the monitoring device (22, 23) in such a way that it is controlled from the conducting state to the nonconducting state if the monitoring device (22, 23) determines that current flows in the monitored current path longer than a prespecified time interval.

3. Control according to claim 1 or 2, characterized in that the control (20) is provided for nursing care beds.

4. Control according to claim 1, characterized in that it permanently blocks every polarity-reversing switch (24, 25) if it ever detects that the time has been exceeded.

5. Control according to claim 1 or 2, characterized in that it has a separate operation in which the block for the polarity-reversing switch(es) (24, 25) or the safety switch (62) can be reset.

6. Control according to claim 1 or 2, characterized in that the input device (21) has a keyboard.

7. Control according to claim 1 or 2, characterized in that the processor device (22, 23) has at least two processors.

8. Control according to claim 7, characterized in that the processors (22, 23) are diverse with respect to hardware.

9. Control according to claim 7, characterized in that the programs running in the processors (22, 23) are diverse with respect to software.

10. Control according to claim 7, characterized in that one of the processors (22, 23) contains the complete control program, and the other, merely a part with safety functions.

11. Control according to claim 1 or 2, characterized in that the polarity-reversing switch (24, 25) has only semiconductor components.

12. Control according to claim 11, characterized in that the polarity-reversing switch (24, 25) has at least two half-bridges (65 . . . 67) and in that the pertinent driving motor (26, 27) lies in the bridge arm.

13. Control according to claim 11, characterized in that the polarity-reversing switch (24, 25) has at least three half-bridges (65 . . . 67) and in that two driving motors (26, 27) are switched into the existing bridge arms, wherein a driving motor (26, 27) lies in each bridge arm.

14. Control according to claim 1 or 2, characterized in that the monitoring device (22, 42) has a current sensor (42).

15. Control according to claim 14, characterized in that the current sensor (42) lies in the current line to all motors (26, 27).

16. Control according to claim 14, characterized in that the current sensor (42) is connected to inputs (44, 45) of the two processors (22, 23).

17. Control according to claim 14, characterized in that a current sensor resistance (42) is provided for every processor (22, 23).

18. Control according to claim 1 or 2, characterized in that the actuation of input keys (31) of the input device (21) is done in a prespecified sequence to reset the control (20) to the normal operating state.

19. Control according to claim 1 or 2, characterized in that the processor device (22, 23) contains a nonvolatile storage unit, in which a value corresponding to the blocking state is stored in such a way that after switching on the voltage for the processor device (22, 23) again, the blocking state is maintained.

20. Control according to claim 1 or 2, characterized in that a mechanical safety switch (62) lies in the current line of at least some driving motors (26, 27).

21. Control according to claim 21 [sic; 20], characterized in that the mechanical safety switch (62) is formed by a bistable relay.

22. Control according to claim 21, characterized in that the safety switch (62) has two magnetic windings (63, 64), one of which is used for resetting.

23. Control according to claim 22, characterized in that the winding (63) for the resetting is connected to the processor device (22, 23).

24. Control according to claim 1 or 2, characterized in that the current limiting value is the current-time integral.
